(19) United States
(12) Patent Application Publication
(10) Pub. No.: US 2010/0081556 A1
(43) Pub. Date: Apr. 1, 2010

(54) Oxide-based ceramic matrix composites

(76) Inventors: Vann Heng, Buena Park, CA (US); Robert A. DiChiara, JR., Carlsbad, CA (US); Susan Saragosa, Artesia, CA (US); Elizabeth Chu, Mountain View, CA (US); Carlos G. Levi, Santa Barbara, CA (US); Frank W. Zok, Goleta, CA (US)

Correspondence Address: DUKE W. YEE, YEE & ASSOCIATES, P.C., P.O. BOX 802333, DALLAS, TX, 75380, US

(21) Appl. No.: 11/491,359

(22) Filed: Jul. 21, 2006

Related U.S. Application Data
(63) Continuation-in-part of application No. 11/134,876, filed on May 23, 2005.

(51) Int. Cl. C04B 35/117; C04B 35/64; C04B 35/10; C04B 35/565

(52) U.S. Cl. 501/89; 264/621; 501/153; 501/95.2

(57) ABSTRACT

An oxide-based ceramic matrix composite and a method of making oxide-based ceramic composite are provided. The oxide-based ceramic matrix composite comprises a ceramic fiber and a mullite-alumina impregnating the ceramic fiber, wherein the mullite-alumina ceramic matrix comprises of 10-70 wt % mullite-alumina mixture.

### CROSS REFERENCE TO RELATED APPLICATIONS

This application is a continuation in part of U.S. patent application Ser. No. 11/134,876 (Publication number 2005/218565) filed on May 23, 2005, the disclosure of which is incorporated herein by reference.

### STATEMENT REGARDING FEDERALLY SPONSORED RESEARCH AND DEVELOPMENT

This invention was made with Government support under contract number F33615-03-2-5202 awarded by the United States Air Force. The government has certain rights in this invention.

### BACKGROUND OF THE INVENTION

1. Field of the Invention

This invention relates to oxide-based ceramic matrix composites (CMC) and a method of making oxide-based ceramic matrix composites (CMC).

2. Background

Composites (also referred to as “composite materials”) are made from two or more constituent materials that remain separate and distinct on a macroscopic level while forming a single component. Matrix (or “binder”) and reinforcement(s) are two main constituents of composites. Matrix holds the reinforcement in an orderly pattern.

Reinforcement is stronger and stiffer than the matrix, and gives the composite its characteristic properties. Reinforcements impart special physical (mechanical and electrical) properties to enhance matrix properties. The matrix material surrounds and supports the reinforcement materials by maintaining their relative positions. The resulting synergy produces material properties unavailable from naturally occurring materials.

Carbon-fibre reinforced plastic (CRP); Glass-fibre reinforced plastic (GRP or “fiberglass”); thermoplastic composites; metal matrix composites (“MMCs”) and Ceramic matrix composites (CMC) are some of the common types of composites.

CMC is formed of a ceramic matrix with fibers as reinforcements. CMC has relatively high mechanical strength at high temperatures. These materials withstand physically demanding conditions such as high temperature, corrosive conditions, oxidation and high acoustic environments.

Glass CMC, organo-metallic CMC and non-oxide CMC are some of the common known composites. These composites have restricted use due to various limitations. Glass CMC has restricted application because it is difficult to manufacture complex shapes with glass CMC. Organo-metallic ceramics are costly, have high dielectric constant and are susceptible to oxidation. Non-oxide CMC finds limited use as its matrix begins to crack at typically about 10 ksi.

In recent years, oxide-based matrix ceramics (also referred to as “oxide CMC”) capable of withstanding higher temperatures have been manufactured. One such oxide CMC has aluminum phosphate bonded alumina oxide CMC as matrix and Nicalon 8 harness satin fabric as reinforcement. However, this matrix suffered phase inversions in the matrix over temperatures of about 1400° F. Other oxide CMC exhibit desirable properties above 1400° F. but fail at temperatures beyond 2000° F. Oxide CMC'S operating beyond 2000° F. (e.g. in space shuttles) are desirable.

Continuous improvements are being made to form oxide-based CMC exhibiting better thermal and structural stability at temperatures of at least up to 2400° F.

Accordingly, it is desirable to manufacture CMCs of various shapes and sizes, which can withstand temperatures of over 2000° F. without degradation. It is also desirable to provide an inexpensive method for manufacturing CMC having various sizes and shapes.

### SUMMARY OF THE PRESENT INVENTION

In one aspect of the present invention, a mullite-alumina ceramic matrix is provided. The mullite-alumina ceramic matrix comprises ceramic powder mixture having mullite-alumina powder and an alumina precursor solution

In another aspect of the present invention, a oxide-based ceramic matrix composite is provided. The oxide-based ceramic matrix comprises a ceramic fiber and mullite-alumina ceramic matrix impregnating the ceramic fiber.

In yet another aspect of the invention, a method of making an oxide-based ceramic matrix composite is provided. The method of making oxide-based ceramic matrix composite comprises preparing an alumina precursor solution; treating the alumina precursor solution with ceramic powder mixture to form homogenous suspension; wherein the ceramic powder mixture has mullite-alumina powder; infiltrating the homogenous suspension into ceramic fiber and form a prepreg; and curing and sintering the prepreg to form a ceramic matrix composite.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE ACCOMPANYING DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following figures.

FIG. 1 shows process steps for preparing oxide-based ceramic matrix composite, according to one aspect of the present invention.

FIG. 2A shows a flow chart for preparing mullite-alumina oxide-based ceramic matrix, according to one aspect of the present invention;

FIG. 2B shows a flow chart for preparing oxide CMC, according to one aspect of the present invention;

### DETAILED DESCRIPTION OF VARIOUS EMBODIMENTS

In one aspect of the present invention, an oxide-based CMC (also referred to as “oxide CMC”) is provided. The oxide CMC of the present invention exhibits thermal and structural stability at temperatures beyond 2000° F. The oxide CMC of the present invention has higher temperature resilience, improved damage resistance and less susceptibility to becoming embrittled at temperatures exceeding 2000° F.

To facilitate an understanding of the oxide based CMC, its components, and method of preparation of oxide based CMC, a general overview of steps for forming the oxide based CMC will be described. The specific steps and components for forming the oxide based CMC will then be described with reference to the general method of forming oxide based CMC.

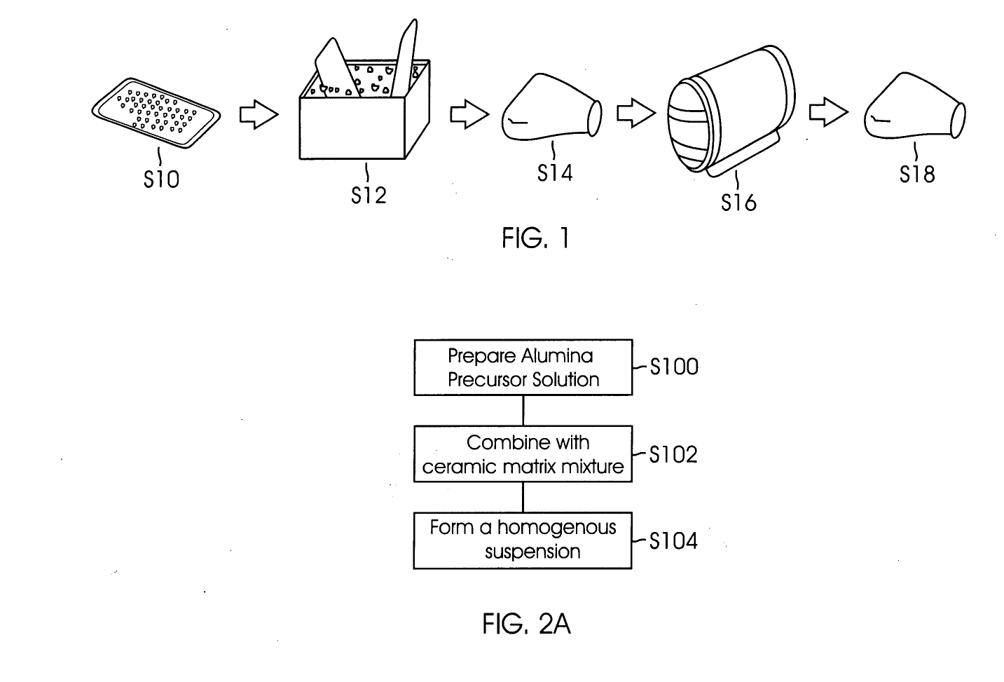

FIG. 1 shows a top level block diagram for forming an oxide based CMC. In step S10, a ceramic fiber is selected. In step S12, the ceramic fiber is impregnated with ceramic powder slurry. In step S14, the impregnated fiber is draped on a tool. In step S16, the draped impregnated fiber is cured. In step S18, free standing firing is performed to form the oxide based CMC.

In one aspect of the present invention, a ceramic powder slurry is formed from a mullite-alumina ceramic matrix (also called “ceramic matrix”). The ceramic matrix comprises an alumina precursor solution combined with a ceramic matrix mixture. The ceramic matrix mixture comprises about 10-70 wt % mullite-alumina powder mixture, up to 25 wt % binder, up to 20 wt % emissivity agents and up to 1 wt % antifoamer. Preferably, submicron alumina and submicron mullite powders are used. In mullite-alumina powder mixture, mullite to alumina ratio varies from 5/95 to 95/5, preferably powder mixture has 73.5 wt % mullite and 26.5 wt % alumina. Binder is preferably an organic binder, Polyvinylpyrrolidone (PVP).

Emissivity agents such as encapsulated Silicon carbide (SiC), Silicon tetraboride (SiB₄)or silicon hexaboride (SiB₆) may be incorporated into the powder slurry to increase surface emissivity. Other emissivity agents such as molybdenum disilicide (MoSi₂) and aluminum phosphate containing carbon may also be added to the ceramic matrix. In a preferred embodiment, the emissivity agents have a particle size between 1-50 microns. Antifoamer is preferably Dow Corning 1410.

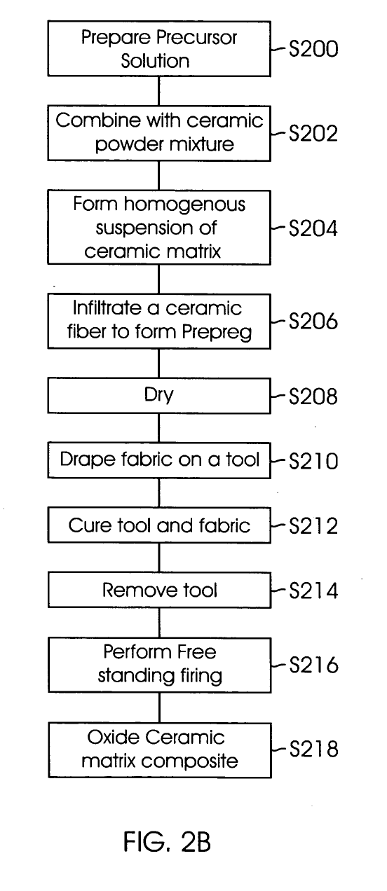

In another aspect of the present invention, a method of preparing mullite-alumina ceramic matrix is provided. FIG. 2A shows a flow diagram for method of making mullite-alumina ceramic matrix. In step S100, an alumina precursor solution having density of about 0.5-5.00 gm/cm³ is prepared.

For preparing alumina precursor solution, 50 to 500 g aluminum chloride hexahydrate is dissolved into 50 to 1500 g DI water. The mixture is heated in a reaction vessel with a cooled reflux condenser to 40-45° C. Aluminum powder of mesh size −40 to 325, ranging from 20 to 400 g, of at least 99% purity, is added to the solution. Temperature of the solution is maintained at 65-75° C. for about 12-15 hours. Solution is then filtered. Resulting alumina precursor solution is then concentrated to adjust the density of the solution to 0.5-2 gm/cm³.

In step S102, the alumina precursor solution is combined with the ceramic matrix mixture to form powder slurry. Preferably, alumina precursor solution of density 1.3 gm/cm³ is combined with ceramic matrix mixture. Ceramic matrix mixture comprises 10-70 wt % mullite-alumina powder mixture, 0-25 wt % PVP, 0-20 wt % of emissivity agent and 0-1 wt % antifoamer.

In step S104, the ceramic powder slurry is made into a homogenous suspension by breaking up the soft-powder agglomerates. Methods of creating a homogenous suspension are well known in the art. Some examples include ball-milling, attrition milling, high-shear mixing and sonic milling. In a preferred embodiment, the mixture is ball-milled with alumina media. Preferably, the mixture is ball-milled for four hours to produce a homogenous non-agglomerated suspension of mullite-alumina ceramic matrix.

FIG. 2B shows a flow diagram of a method for forming an oxide-based ceramic composite, according to one aspect of the present invention. In step S200, an alumina precursor solution of a desired density is prepared. In step S202, the alumina precursor solution is combined with mullite-alumina ceramic mixture to form powder slurry. In step S204, the ceramic powder slurry is ball milled for about 4 hours to form a homogenous suspension of mullite-alumina ceramic matrix.

In step S206, the ceramic powder slurry is impregnated into various woven ceramic fiber cloths using any of the commonly used infiltrating methods to form a prepreg. For complete and uniform infiltration, doctor's blade or a pinched-roller set-up is used to form the prepreg. Ceramic fibers are chosen from 4-harness satin, 8-harness satin or plain weave of oxide fibers such as Nextel 312, Nextel 550, Nextel 610, Nextel 620, Nextel 650, Nextel 720, Altex or Almax Quartz, and non oxide fibers such as SiC fibers like Nicalon (CG, HiNicalon or syramic) and Tyranno (SA or ZMI). The preferred fibers for high-temperature use are, but not limited to, Nextel 720 or Tyranno SA.

In step S208, the prepreg fabric is dried to develop a tack and then draped on a desired complex tool in step S210 to form a prepreg fabric of desired thickness and shape. The tool and the prepreg fabric is then cured and becomes rigid in step S212. Curing is preferably done at 350° F. in a vacuum bag. Curing may be carried out with pressure, of about 30-100 psi, or without pressure, by using a press or an autoclave. Curing at 350° F. helps in removal of volatile components and the matrix starts to become rigid. The alumina precursor bonds the mullite and alumina powders together. Selection of process for drying and curing depends on size and shape of the tool.

In step S214, the tool is removed after 350° F. curing and the dried infiltrated part retains its desired shape. In step S216, free standing infiltrated part is sintered between 1500-2400° F., preferably at 2200° F., for about two hours, forming oxide CMC in step S218. Sintering of the free standing part does not use any special tooling. This reduces manufacturing cost. Sintering at high temperatures facilitates reaction between dried alumina precursor with the mullite and the alumina powder mixture, while completely volatizing organic components. This gives the CMC its high strength.

In a further embodiment, the steps of infiltrating, drying and curing can be repeated to achieve the desired density of the CMC. Bleeding of the composite can be done with bleeder plies if necessary to reduce matrix porosity and build-up at the surfaces.

Mullite and alumina powders both are high-temperature materials that do not sinter readily at temperatures above 2000° F., thus preventing strong bonding to the fibers or even to themselves.

In oxide-based CMC of the present invention, mullite-alumina based matrix is porous and therefore, matrix and fibers have a weak interface. This weak interface deflects the cracks and distributes the load to other fibers, causing the cracks to absorb energy. This is the ideal fracture mechanism needed for CMCs to achieve higher toughness and to improve strength stability.

CMC material of present invention has many potential applications, especially for harsh environments, including spacecraft, aircraft and missiles. The potential applications include X-37, X-43, X-45, Shuttle, new reentry space vehicles, aircraft and missile and ground based turbines and other equipments using extreme environments.

The foregoing and other aspects of the teachings may be better understood in connection with the following examples, which are presented for purposes of illustration and not by way of limitation.

### Example 1

### Prepare an Alumina Precursor

The alumina precursor solution is made by dissolving 202.80 grams of reagent grade Aluminum Chloride Hexahydrate (AlCl₃-6H₂O) into 800 g DI water. The solution is heated in a reaction vessel with a cooled reflux condenser to 40-45° C. Approximately 113.28 grams of aluminum powder of −40 to +325 mesh with at least 99.8% purity is slowly added to the solution. As the aluminum powder reacts, an exothermic reaction occurs. After reaction is complete, the solution is kept at 65-75° C. for ˜12-15 hours. The solution is filtered and the concentration is adjusted to a density of ˜1.3-2.0 g/cm³.

### Example 2

### Prepare Slurry

To make ceramic powder slurry for the CMC prepreg process, the alumina precursor solution at a density of 0.5 to 5.0 g/cm³, preferably 1.3 to 2.0 g/cm³, is combined with alumina powder (AKP-50 from Sumitomo Chemical Co. LTD) and mullite powder (KM101 from Kyoritsu Ceramic Materials or MU107 from Sowa Denko) at a concentration of 10-70 wt % powder, preferably 50 wt %. The mullite to alumina powder ratio varies from 5/95 to 95/5, preferably 73.5 wt % mullite and 26.5 wt % alumina. This mixture is combined with 0 to 25 wt %, preferably 15 wt % PVP (from Sigma Aldrich), 0-20% of emissivity agent (preferably 4-8 wt %), and 0 to 1 wt % Dow Corning 1410 (antifoamer).

### Example 3

### Prepare Prepreg

Prepreg: The ceramic powder slurry is impregnated into a woven oxide cloth (4 or 8 hardness satin) such as Nextel 312, Nextel 440, Nextel 550, Nextel 720, Nextel 610 or a woven non-oxide cloth such Tyranno SA or Nicalon CG. The impregnation of the cloth is done using a doctor blade setup producing a wet prepreg.

### Example 4

### Prepare Mullite-Alumina Ceramic Matrix Composite

364.8 grams of alumina precursor solution (density 1.3 g/cm³) is combined with 111.8 grams of alumina powder (AKP-50), 316.8 grams of mullite powder (MU107), 66.6 grams of PVP (PVP-10), 40 grams of SiC powder, 140.0 grams DI water and 5 drops of antifoam Dow Corning 1410 and then ball milled for 4 hours to form a ceramic powder slurry.

The mixture is infiltrated into a woven oxide cloth (4 or 8 hardness satin) such as Nextel 312, Nextel 440, Nextel 550, Nextel 720, Nextel 610 or a woven non-oxide cloth such as Tyranno SA or Nicalon CG, using a doctor blade or a pinched roller set up to form a wet prepreg. The multiple plies of CMC prepreg are draped or laid up on complex tools, vacuum bagged having standard bleeders and breathers used in the organic composite industry and autoclaved to 350° F. After exposing the matrix to heat to set the matrix, the vacuum bag and tools are removed. The resulting part is post cured free standing between 1500° F. and 2400° F., preferably 2200° F.

### Example 5

### Prepare Mullite-Alumina Ceramic Matrix Composite

137 grams of alumina precursor solution (density 1.3 g/cm³) is combined with 42 grams of alumina powder (AKP-50), 119 grams of mullite powder (MU107) and 25 grams of PVP (PVP-10) and then ball milled for 4 hours to form ceramic powder slurry. The fabric is infiltrated by the same method as described in Example 1.

Those skilled in the art can now appreciate from the foregoing description that the broad teachings can be implemented in a variety of forms. Therefore, while the teachings have been described in connection with particular examples thereof, the true scope of the teachings should not be so limited since other modifications will become apparent to the skilled practitioner upon study of the specification, examples and following claims.

1. A mullite-alumina ceramic matrix, comprising:
a ceramic powder mixture comprising between 10 wt % and 70 wt % of mullite-alumina powder, and between an amount greater than zero and 25 wt % of a binder; and
an alumina precursor solution.

2. (canceled)

3. The mullite-alumina ceramic matrix of claim 1, wherein the mullite-alumina powder of the ceramic powder mixture comprises mullite and alumina in a ratio varying from 5 parts mullite and 95 parts alumina by weight to 95 parts mullite and 5 parts alumina by weight.

4. (canceled)

5. The mullite-alumina ceramic matrix of claim 4, wherein the binder is an organic binder comprising Polyvinylpyrollidone (PVP).

6. The mullite-alumina ceramic matrix of claim 1, wherein the ceramic powder mixture further comprises between an amount of greater than zero and 20 wt % of an emissivity agent.

7. The mullite-alumina ceramic matrix of claim 6, wherein the emissivity agent is selected from the group consisting of Silicon carbide (SiC), encapsulated silicon carbide, Silicon tetraboride (SiB₄), silicon hexaboride (SiB₆), molybdenum disilicide (MoSi₂), aluminum phosphate containing carbon, and combinations thereof.

8. The mullite-alumina ceramic matrix of claim 1, wherein the alumina precursor solution has a density between 0.5 gm/cm³ and 5.0 gm/cm³.

9. An oxide-based ceramic matrix composite, comprising:
a ceramic fiber; and
mullite-alumina ceramic matrix impregnating the ceramic fiber, wherein the mullite-alumina ceramic matrix comprises a ceramic powder mixture comprising between 10 wt % and 70 wt % of mullite-alumina powder, and between an amount greater than zero and 25 wt % of a binder and an alumina precursor solution.

10. (canceled)

11. (canceled)

12. The oxide-based ceramic matrix composite of claim 10, wherein mullite to alumina powder ratio in the mullite-alumina powder mixture varies from 5 parts mullite and 95 parts alumina by weight to 95 parts mullite and 5 parts alumina by weight.

13. (canceled)

14. The oxide-based ceramic matrix composite of claim 10, wherein the ceramic powder mixture comprises an amount of emissivity agent in a range of greater than zero up to 20 wt %.

15. The oxide-based ceramic of claim 14, wherein the emissivity agents are based on Silicon carbide (SiC), Silicon tetraboride (SiB₄), silicon hexaboride (SiB₆), molybdenum disilicide (MoSi₂) and aluminum phosphate containing carbon.

16. The oxide-based ceramic of claim 9, wherein the alumina precursor solution has a density between 0.5-5.0 gm/cm³.

17. A method of making an oxide-based ceramic matrix composite comprising:
preparing an alumina precursor solution;
treating the alumina precursor solution with ceramic powder mixture to form a homogenous suspension; wherein the ceramic powder mixture has mullite-alumina powder;
infiltrating the homogenous suspension into ceramic fiber and form a prepreg;
curing and sintering the prepreg to form a ceramic matrix composite.

18. The method of claim 17, wherein the ceramic powder mixture comprises of 10-70% mullite-alumina powder.

19. The method of claim 17, wherein the alumina precursor solution has a density between 0.5-5.0 gm/cm³.

20. The method of clam 17, wherein the curing occurs at about 350° F. in a vacuum bag.

21. The method of claim 17, wherein the sintering occurs between 1500° F.-2400° F.

22. The oxide-based ceramic matrix composite of claim 9, wherein the ceramic fiber is selected from the group consisting of 4-harness satin, 8-harness satin, oxide fibers, non-oxide fibers, and combinations thereof.

23. The oxide-based ceramic matrix composite of claim 22, wherein the ceramic fiber is an oxide fiber selected from the group consisting of Nextel 312 fibers, Nextel 550 fibers, Nextel 610 fibers, Nextel 620 fibers, Nextel 650 fibers, Nextel 720 fibers, Altex fibers, Almax quartz fibers, and combinations thereof.

24. The oxide-based ceramic matrix composite of claim 22, wherein the ceramic fiber is an non-oxide fiber selected from the group consisting of silicon carbide fibers, tyranno fibers, and combinations thereof.
